(19) United States
(12) Patent Application Publication
(10) Pub. No.: US 2016/0266912 A1
(43) Pub. Date: Sep. 15, 2016

(54) EXTERNAL DEVICES, ELECTRONIC DEVICES, METHODS FOR STARTING EXTERNAL DEVICES, AND METHODS FOR DATA PROCESSING

(71) Applicant: MediaTek Singapore Pte. Ltd., Singapore (SG)

(72) Inventors: Xiaoyong YE, Sichuan Province (CN); Liang XING, Sichuan Province (CN); Haijun LIU, Sichuan Province (CN); Gaosen ZHANG, Sichuan Province (CN)

(21) Appl. No.: 15/059,220

(22) Filed: Mar. 2, 2016

(30) Foreign Application Priority Data
Mar. 13, 2015 (CN) 201510111678.1

(51) Int. Cl. G06F 9/445; G06F 9/44

(52) U.S. Cl. CPC G06F 9/44505; G06F 9/4401; G06F 8/61

(57) ABSTRACT

The present invention provides an external device, including a Boot ROM, a processing module, an internal RAM, and an external RAM. The Boot ROM implements a hardware initialization when receiving a boot command, and stores a download agent protocol and a communication interface protocol. The processing module creates a communication channel with the electronic device according to the communication interface protocol, downloads a download agent application from the electronic device through the communication channel according to the download agent protocol, downloads startup firmware for a startup program by the download agent application from the electronic device, and implements the startup program according to the startup firmware after implementing the hardware initialization. The internal RAM stores the download agent application. The external RAM stores the startup firmware.

### CROSS REFERENCE TO RELATED APPLICATIONS

This Application claims priority of China Patent Application No. 201510111678.1, filed on Mar. 13, 2015, the entirety of which is incorporated by reference herein.

### BACKGROUND OF THE INVENTION

1. Field of the Invention

The application relates in general to an external device, an electronic device, a data processing system, a method for starting an external device and a method for data processing, and in particular to an external device, an electronic device, a data processing system, a method for starting the external device and a method for data processing which are used for dynamically downloading firmware for a startup program or a processing program from a host through a communication interface.

2. Description of the Related Art

With the development of the technology, electronic devices with different functions are used widely. Due to the increasingly powerful functions of some electronic devices with specific functions, such as modems, wireless network cards, printers, and other external devices, systems have become complex. In general, firmware for an external device is typically stored in the non-volatile memory of the external device, such as ROM. After the external device is enabled, the firmware is loaded to the RAM from the ROM, and processed by the CPU of the external device. However, the complexity of this system can make the storage space required of the external device larger, and increase the cost of the external device. Thus, how to reduce the cost of the external device without affecting the processing efficiency of the external device is the current problem that needs to be solved.

### BRIEF SUMMARY OF INVENTION

An embodiment of the invention provides an external device, adapted to connect to an electronic device, including a Boot ROM, a processing module, an internal RAM, and an external RAM. The Boot ROM is configured to implement a hardware initialization when receiving a boot command. The Boot ROM only stores a download agent protocol and a communication interface protocol. The processing module is configured to create a communication channel with the electronic device according to the communication interface protocol after implementing the hardware initialization. The processing module is also configured to download a download agent application from the electronic device through the communication channel according to the download agent protocol. The processing module is also configured to download startup firmware for a startup program by the download agent application from the electronic device. The processing module is also configured to implement the startup program according to the startup firmware. The internal RAM is configured to store only the download agent application. The external RAM is configured to store the startup firmware.

Another embodiment of the invention provides an electronic device, adapted to connect to an external device, including a storage module and a processing module. The storage module is configured to store a download agent protocol, a communication interface protocol, and startup firmware for implementing a startup program of the external device. The processing module is configured to create a communication channel with the external device according to a communication command of the startup program of the external device and the communication interface protocol. The processing module is also configured to transmit a download agent application to the external device through the communication channel according to a download command and the download agent protocol. The processing module is also configured to transmit the startup firmware to the external device by the download agent application for implementing the startup program.

Another embodiment of the invention provides a data processing system, including: an electronic device and an external device. The electronic device includes a storage module and a first processing module. The storage module is configured to store a download agent protocol, a communication interface protocol, and startup firmware for implementing a startup program. The first processing module is configured to output the startup firmware according to the download agent protocol and the communication interface protocol. The external device includes a Boot ROM, a second processing module, an internal RAM, and an external RAM. The Boot ROM is configured to implement a hardware initialization when receiving a boot command, and only store the download agent protocol and the communication interface protocol. The second processing module is configured to output a communication command to the first processing module after implementing the hardware initialization, create a communication channel with the electronic device according to the communication interface protocol, download a download agent application from the electronic device through the communication channel according to the download agent protocol, download the startup firmware by the download agent application from the electronic device, and implement the startup program according to the startup firmware. The internal RAM is configured to only store the download agent application The an external RAM is configured to store the startup firmware.

Another embodiment of the invention provides a method for starting the external device, wherein the external device has an internal RAM and an external RAM, and the external device connects with an electronic device through a communication interface. The method includes: receiving a boot command; creating a communication channel with the electronic device according to the boot command and a communication interface protocol; downloading a download agent application from the electronic device to the internal RAM through the communication channel according to a download agent protocol; downloading startup firmware for a startup program from the electronic device by the download agent application; and implementing the startup program according to the startup firmware.

Another embodiment of the invention provides a method for data processing, adapted between an electronic device and an external device, wherein the electronic device connects with the external device through a communication interface, comprising: creating a plurality of virtual channels between the electronic device and the external device by a middleware; sending a request command to the electronic device through the virtual channels from the external device to the electronic device, wherein the request command correplies to an access request of a File System; implementing an operation according to the request command by the electronic device; and responding by sending an operating result corresponding to the operation to the external device by the electronic device.

The external device, the electronic device, the data processing system, the method for starting the external device, and the method for data processing provided in the invention can reduce the manufacturing cost.

### BRIEF DESCRIPTION OF DRAWINGS

The invention can be more fully understood by reading the subsequent detailed description and examples with references made to the accompanying drawings, wherein:

FIG. 1 is a schematic drawing of an external device in accordance with an embodiment of the invention;

FIG. 2 is a schematic drawing of an electronic device in accordance with an embodiment of the invention;

FIG. 3 is a schematic drawing of a data processing system in accordance with an embodiment of the invention;

FIG. 4 is a flow chart of a method for starting the external device in accordance with an embodiment of the invention;

FIG. 5 is a flow chart of a method for data processing in accordance with an embodiment of the invention.

### DETAILED DESCRIPTION OF INVENTION

The specification and claims use particular terminology to refer to specific components. Persons skilled in the art will understand that manufacturers may use different terms to refer to the same components. The differences of the components in the specification and the claims is not defined by the differences in the name, but based on the functions of the components. The word “couple” mentioned in the specification and claims may refer to any direct and/or indirect electrical coupling. Accordingly, if a first device is described as being coupled to a second device, the first device may be coupled directly to the second device, or it may be indirectly coupled to the second device through another device or another means of coupling. The accompanying drawings and the following embodiments of the invention will be described in detail.

The following description is a preferred embodiment of the present invention for describing the principles of the invention, but it is not intended to limit the scope of the invention. It should be noted that the embodiment of the present invention can be implemented by software, hardware, firmware, or any combination thereof.

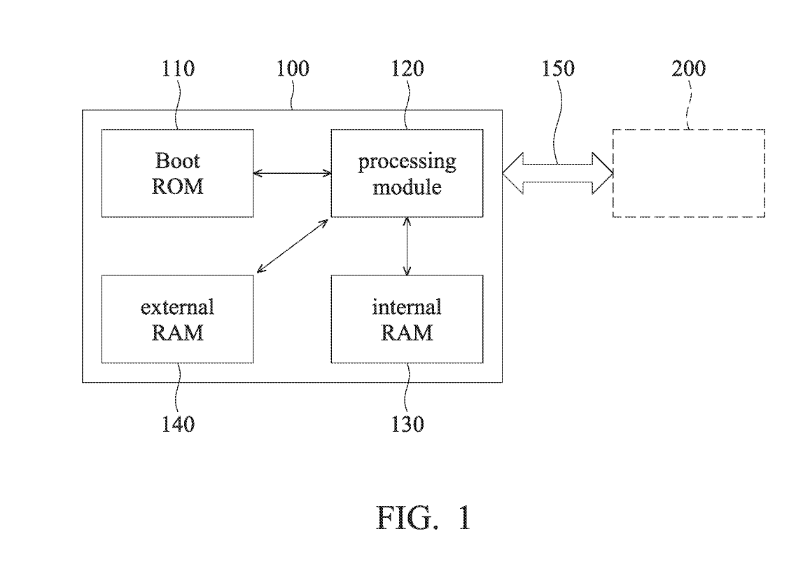

FIG. 1 is a schematic drawing of an external device 100 in accordance with an embodiment of the invention. As shown in FIG. 1, the external device 100 includes a Boot ROM 110, a processing module 120, an internal RAM 130, an external RAM 140, and a communication interface 150. The Boot ROM 110 implements a hardware initialization, and can only store basic boot code for implementing the hardware initialization, a download agent protocol, and a communication interface protocol. The processing module 120 creates a communication channel with the electronic device 200 through the communication interface 150 according to the communication interface protocol, downloads startup firmware for a startup program according to the download agent protocol, and implements the startup program according to the startup firmware. The internal RAM 130 stores the download agent application. The external RAM 140 stores the startup firmware. It should be noted that the internal RAM 130 and the external RAM 140 can be replaced by a RAM, and the function of the RAM is the same as the internal RAM 130 and the external RAM 140, but it is not limited thereto.

According to an embodiment of the invention, the external device 100 downloads the startup firmware for implementing the startup program from the electronic device 200 and implements the startup program when the external device 100 connects with the electronic device 200 through the communication interface 150. The Boot ROM 110 implements the hardware initialization according to the basic boot code. The processing module 120 creates the communication channel with the electronic device 200 according to the communication interface protocol after implementing the hardware initialization. The communication channel can be a USB (Universal Serial Bus), serial ports, a parallel interface, SATA (Serial Advanced Technology Attachment), Wi-Fi, Bluetooth, SDIO (Secure digital input/output interface), etc. The processing module 120 downloads a download agent application from the electronic device 200 to the internal RAM 130 through the communication channel according to a download agent protocol stored in the Boot ROM 110 after creating the communication channel. The processing module 120 downloads the startup firmware, such as an image file, for the startup program from the electronic device 200 to the external RAM 140 by the download agent application, and implements the startup program according to the startup firmware. The internal RAM 130 can be memory which has a faster access speed, such as SRAM, and the external RAM 140 can be memory which has a slower access speed, such as DDR-RAM or D-RAM. It should be noted that the external RAM 140 can be provided on the outside of the external device 100, and electrically connects to the external device 100 in the form of external electrical connection, or can be provided as an external RAM 140 with a smaller capacity, and the external RAM 140 might use another external RAM to expand the capacity for reducing the cost when the capacity is not sufficient.

According to another embodiment of the invention, the processing module 120 obtains a middleware subscriber unit from the startup firmware downloaded from the external device when the external device 100 finishes the startup program, and creates a plurality of virtual channels coupled with the electronic device by the middleware subscriber unit and the middleware service unit of the electronic device 200 for implementing the data processing program. The virtual channel can be a channel for delivering the document file, implementing the Remote Procedure Call, implementing the remote control, etc. Each virtual channel has a fixed API (Application Programming Interface), and the middleware transmits the data with the electronic device according to the API. The processing module 120 further determines the priority of the virtual channels according to a priority distribution table, and processes the data according to priority, such as by first processing the highest-priority data. When the external device 100 needs to access the files from the File System, due to the external device 100 not having any File System, the external device 100 sends the access command to the electronic device for accessing the file. For example, when the processing module 120 receives the access request corresponding to the File System, the file message of the accessed files is represented as a specific parameter by a specific protocol format, and will be packed into a plurality of packages and sent to the electronic device through the virtual channel. The electronic device implements the operation corresponding to accessed files according to the path information of the document file in the request command, packs the operating result into a plurality of packages, and replies by sending the packages to the processing module 120 through the virtual channel.

According to another embodiment of the invention, the processing module 120 obtains the voltage level of the General Purpose I/O pin by implementing the Remote Procedure Call through the virtual channel.

According to another embodiment of the invention, after the middleware is enabled, the processing module 120 further detects whether there is a new communication interface connected to the external device by the middleware. If a new communication interface is detected, the processing module 120 creates a new communication channel with the electronic device according to the communication interface protocol and creates a new virtual channel by the middleware, and determines the priority of the virtual channel according to the priority distribution table.

It should be noted that, according to another embodiment of the invention, the Boot ROM 110 and the internal RAM 130 can be included in the processing module 120. Due to there being no other ROM except the Boot ROM 110 included in the external device 100, when the external device 100 needs to implement the startup program or other processing programs, the external device 100 dynamically downloads the firmware from the electronic device (host) to the RAM 150, or sends the operation command to the electronic device for implementing the corresponding operation. In this way, hardware costs can be reduced and storage efficiency can be improved.

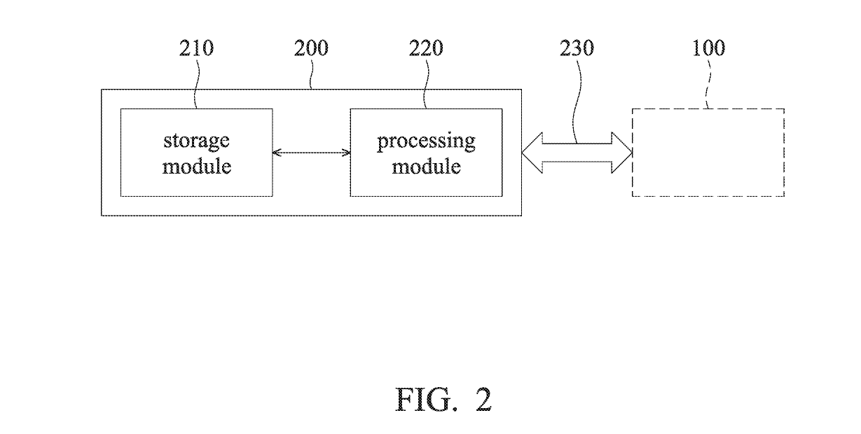

FIG. 2 is a schematic drawing of an electronic device in accordance with an embodiment of the invention. The electronic device 200 includes a storage module 210 and a processing module 220, and connects with the external device 100 through the communication interface 230. The storage unit 210 stores the download agent protocol, the communication interface protocol, and the startup firmware for implementing the startup program of the external device. It should be noted that the electronic device 300 can be an embedded device such as a smartphone or tablet, or it can be a host device such as a computer server, but it is not limited thereto.

According to an embodiment of the invention, when the electronic device 200 connects with the external device 100 through the communication interface 230, and detects that the external device is implementing the startup program, the electronic device 200 creates the communication channel with the external device according to the communication interface protocol through the communication interface 230. The communication channel can be a USB (Universal Serial Bus), serial ports, a parallel interface, SATA (Serial Advanced Technology Attachment), Wi-Fi, Bluetooth, SDIO (Secure digital input/output interface), etc. After the communication channel is created, the processing module 220 sends the download agent application to the external device according to the communication interface protocol through the communication channel. After sending the download agent application, the processing module 220 further sends the startup firmware for implementing the startup program, such as the image file, to the external device by the download agent application, so that the external device can implement the startup program according to the startup firmware.

According to another embodiment of the invention, the processing module 220 creates a plurality of virtual channels coupled with the external device by the middleware after the external device finishes the startup program. The middleware includes the middleware service unit and the middleware subscriber unit, and the middleware service unit and the middleware subscriber unit are included in the storage module 210 of the electronic device 200 and the firmware of the external device, respectively. The virtual channel can be a channel for delivering the document file, implementing the Remote Procedure Call, implementing the remote control, etc. Each virtual channel has a fixed API, and the middleware transmits the data with the external device according to the fixed API. When the external device 100 does not store any file system and want to access the file, the external device 100 may transmit access command to the electronic device 200 for accessing the file through the communication channel. For example, when the processing module 220 receives the access request corresponding to the File System, the processing module 220 implements the operation corresponding to the accessed files according to the path information of the document file in the request command, and replies by sending the packed operating result to the external device through the virtual channel.

According to another embodiment of the invention, the processing module 220 further implements the Remote Procedure Call that corresponds to the external device through the virtual channel, and replies by sending the voltage level of the General Purpose I/O pin to the external device according to the request command corresponding to the Remote Procedure Call.

According to another embodiment of the invention, after the middleware is enabled, the processing module 220 further uses the middleware to detect whether there is a new connected communication interface. If a new communication interface is detected, the processing module 220 creates a new communication channel with the external device according to the communication interface protocol and creates a new virtual channel by the middleware.

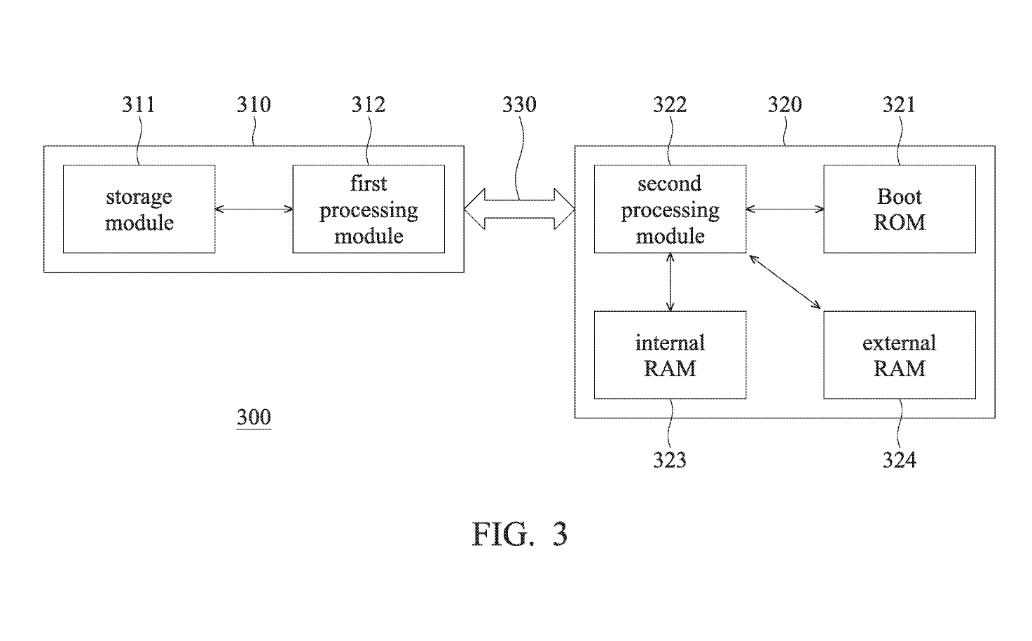

FIG. 3 is a schematic drawing of a data processing system in accordance with an embodiment of the invention. The data processing system 300 includes an electronic device 310 and an external device 320. The electronic device 310 includes a storage module 311 and a first processing module 312. The storage module 311 stores the download agent protocol, the communication interface protocol, and the startup firmware for implementing the startup program. The first processing module 312 outputs the startup firmware according to the download agent protocol and the communication interface protocol. The external device 320 includes a Boot ROM 321, a second processing module 322, an internal RAM 323 and an external RAM 324. The Boot ROM 321 implements the hardware initialization, and only stores the basic boot code, the download agent protocol and the communication interface protocol. The second processing module 322 creates a communication channel with the electronic device 310 according to the communication interface protocol, downloads the startup firmware from the electronic device through the communication channel according to the download agent protocol, and implements the startup program according to the startup firmware. The internal RAM 323 stores the download agent application. The external RAM 324 stores the startup firmware.

According to an embodiment of the invention, the external device 320 downloads the startup firmware for implementing the startup program from the storage module 311 of the electronic device 310 through the communication interface 330 when the external device 320 connects with the electronic device 310 through the communication interface 330 and implements the startup program. The Boot ROM 321 implements the hardware initialization according to the basic boot code. The first processing module 312 creates the communication channel with the second processing module 322 according to the communication interface protocol after implementing the hardware initialization. The communication channel can be a USB interface, serial ports, a parallel interface, SATA, Wi-Fi, Bluetooth, the SDIO, etc. After the communication channel is created, the first processing module 312 sends the download agent application to the internal RAM 323 of the external device 320 according to the download agent protocol stored in the storage module 311. The second processing module 322 downloads the startup firmware, such as an image file, for the startup program from the storage module 311 to the external RAM 324 by the download agent protocol and the download agent application stored in the Boot ROM 321 through the communication channel, and implements the startup program according to the startup firmware. The internal RAM 323 can be memory which has a faster access speed, such as SRAM, and the external RAM 324 can be memory which has a slower access speed, such as DDR-RAM or D-RAM. It should be noted that the external RAM 324 can be provided on the outside of the external device 320, and electrically connects to the external device 320 in the form of external electrical connection, or can be provided as an external RAM 324 with a smaller capacity, and the external RAM 324 might use another external RAM to expand the capacity for reducing the cost of the external device 320 when the capacity is not sufficient.

According to another embodiment of the invention, the first processing module 312 creates a plurality of virtual channels connected with the external device 320 by the middleware when the external device 320 finishes the startup program. The middleware includes the middleware service unit and the middleware subscriber unit, and the middleware service unit and the middleware subscriber unit are included in the storage module 311 of the electronic device 310 and the firmware of the external device 320, respectively. The virtual channel can be a channel for delivering the document file, implementing the Remote Procedure Call, implementing the remote control, etc. Each virtual channel has a fixed API, and the middleware transmits the data between the electronic device 310 and the external device 320 according to the API. The second processing module 322 further determines the priority of the virtual channels according to a priority distribution table, and processes the data according to priority, such as by first processing the highest-priority data.

According to another embodiment of the invention, when the external device 320 needs to access the files from the File System, due to the external device 320 not having any File System, the external device 320 will send the access command to the electronic device 310 for accessing the file. For example, when the second processing module 322 receives the access request corresponding to the File System, the file message of the access file is represented as a specific parameter by a specific protocol format, and the file message is packed into a plurality of packages and sent to the first processing module 312 through the virtual channel. The first processing module 312 will implement the operation corresponding to accessed files according to the path information of the document file in the request command, pack the operating result into a plurality of packages, and reply by sending the packages to the second processing module 322 through the virtual channel.

According to another embodiment of the invention, the second processing module 322 obtains the voltage level of the General Purpose I/O pin by implementing the Remote Procedure Call through the virtual channel. After the first processing module 312 obtains the voltage level of the General Purpose I/O pin, the information will be represented as a specific parameter by a specific protocol format, and will be packed into a plurality of packages and sent to the second processing module 322 through the virtual channel.

According to another embodiment of the invention, after the middleware is enabled, the first processing module 312 and the second processing module 322 further detect whether there is a new communication interface. If a new communication interface is detected, a new communication channel is created according to the communication interface protocol and a new virtual channel will be created by the middleware. The second processing module 322 further determines the priority of the virtual channel according to the priority distribution table.

It should be noted that, according to another embodiment of the invention, the Boot ROM 321 and the internal RAM 323 can be included in the processing module 322. Due to there being no other ROM except the Boot ROM 321 included in the external device 320, when the external device 320 needs to implement the startup program or other processing programs, the external device 320 dynamically downloads the firmware from the electronic device 310 (host) to the RAM 324, or sends the operation command to the electronic device for implementing the corresponding operation. This method reduces hardware costs and improves storage efficiency.

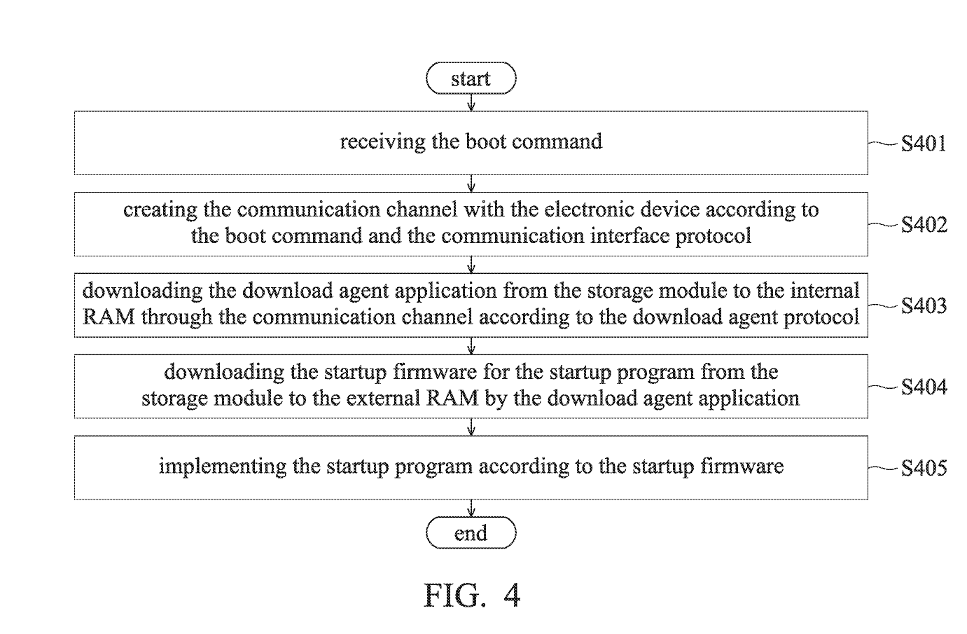

Please refer to FIG. 3 and FIG. 4. FIG. 4 is a flow chart of a method for starting the external device in accordance with an embodiment of the invention. In step S401, the second processing module 322 receives the boot command. The electronic device determines whether the external device has already connected to the electronic device by detecting the status of the interface connected to the external device. If the connection is created, the electronic device triggers the boot command of the external device. Otherwise, the electronic device will not trigger the boot command of the external device. Furthermore, the electronic device can trigger the boot command of the external device manually. In step S402, the second processing module 322 creates the communication channel with the electronic device 310 according to the boot command and the communication interface protocol. In step S403, the second processing module 322 downloads the download agent application from the storage module 311 to the internal RAM 323 through the communication channel according to the download agent protocol. In step S404, the second processing module 322 downloads the startup firmware for the startup program from the storage module 311 to the external RAM 324 by the download agent application. The startup firmware is chosen after the electronic device triggers the boot command of the external device. In addition, the startup firmware for the external device can be the only startup firmware, or different firmware can correspond to different situations, such as different locations or different uses. In step S405, the second processing module 322 implements the startup program according to the startup firmware.

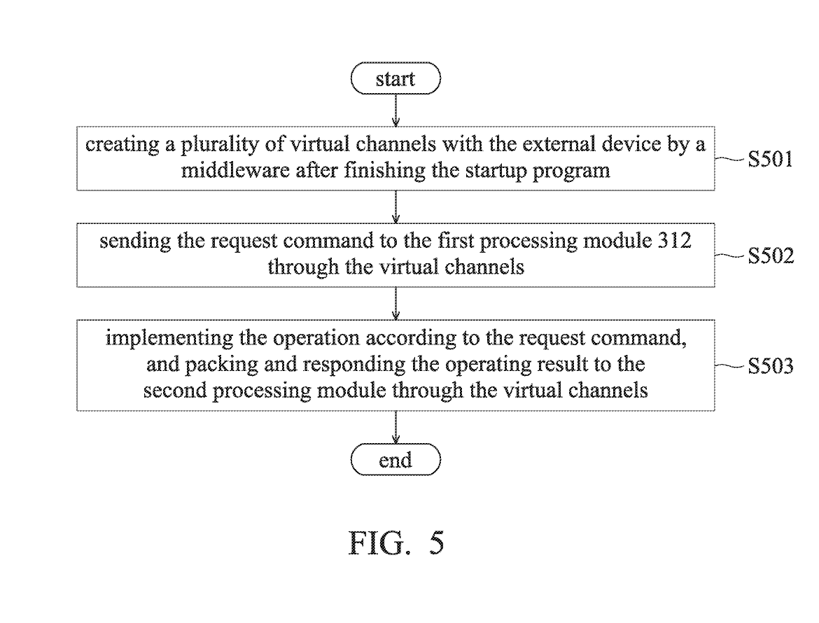

Please refer to FIG. 3 and FIG. 5. FIG. 5 is a flow chart of a method for data processing in accordance with an embodiment of the invention. In step S501, the first processing module 312 creates a plurality of virtual channels with the external device 320 by a middleware after finishing the startup program. In step S502, the second processing module 322 sends the request command to the first processing module 312 through the virtual channels. In step S503, the first processing module 312 implements the operation according to the request command, and packs and replies by sending the operating result to the second processing module 322 through the virtual channels.

According to another embodiment of the invention, the request command correplies to the access request of the File System. The first processing module 311 presents the file message of the access file as a specific parameter by a specific protocol format, and packs the file message to the first processing module 312 through the virtual channel. The first processing module 312 will implement the operation according to the path information of the document file in the request command, pack the operating result into a plurality of packages, and reply by sending the packages to the second processing module 322 through the virtual channel.

According to another embodiment of the invention, the request command correplies to the status request of the General Purpose I/O pin of the electronic device 310. The second processing module 322 obtains the voltage level of the General Purpose I/O pin by implementing the Remote Procedure Call through the virtual channel. After the first processing module 312 obtains the voltage level of the General Purpose I/O pin, the information is represented as a specific parameter by a specific protocol format, and packed into a plurality of packages, and then sent to the second processing module 322 through the virtual channel.

As described above, the invention provides an external device, an electronic device, a data processing system, a method for starting the external device, and a method for data processing. The external device can implement the startup program according to the startup firmware downloaded from the electronic device (host device) through the communication channel without having the EEPROM. After finishing the startup program, the external device can access the File System of the host device to achieve the purpose of sharing hardware and software resources. In addition, the efficiency of downloading the firmware can be improved and the coast of the external device can be reduced by downloading the file using the download agent application stored in the RAM with small capacity and faster access speed, and storing the firmware with larger size in another RAM with large capacity and slower access speed.

Those skilled in the art can present the invention for the particular application and the need according to the description. Various modifications of the embodiments will be apparent to the skilled artisan, and may apply to another embodiment according to basic principles of the above definition. Thus, the present invention is not limited to the specific embodiments, but meets to the widest scope of the disclosed principles and novel features. In the above description, various specific details are used to provide a thorough understanding of the present invention. However, one skilled in the art can understand that the present invention can be implemented by the above description.

The embodiments of the data transmission methods of the present invention can be implemented by hardware, software coding, or a combination of the two. For example, the embodiment of the present invention can be integrated into a circuit with a video compression chip or video compression software for implementing the code. The embodiment of the present invention can be code which is implemented in the Digital Signal Processor (DSP). The present invention may also be related to a variety of functions implemented in a computer processor, a digital signal processor, a microprocessor, or a Field Programmable Gate Array (FPGA). The present invention can be implemented by a processor executing machine-readable software code or firmware code. The software code or firmware code can be any type of programming language, or decoded by different target platforms. However, the software code and other software code with different types, or language are within the scope or spirit of the invention.

It will be apparent to those skilled in the art that various modifications and variations can be made to the structure disclosed without departing from the scope or spirit of the invention. In view of the foregoing, it is intended that the present invention covers modifications and variations of this invention, provided they fall within the scope of the following claims and their equivalents.

What is claimed is:

1. An external device, adapted to couple to an electronic device, comprising:
a Boot ROM, configured to implement a hardware initialization when receiving a boot command, and store a download agent protocol and a communication interface protocol;
a processing module, configured to create a communication channel with the electronic device according to the communication interface protocol, download a download agent application from the electronic device through the communication channel according to the download agent protocol, download startup firmware for a startup program by the download agent application from the electronic device, and implement the startup program according to the startup firmware after implementing the hardware initialization;
an internal RAM, configured to store the download agent application; and
an external RAM, configured to store the startup firmware.

2. The external device as claimed in claim 1, wherein the processing module further creates a plurality of virtual channels coupled with the electronic device after finishing the startup program.

3. The external device as claimed in claim 2, wherein the processing module determines the priority of the plurality of virtual channels according to a priority distribution table.

4. The external device as claimed in claim 2, wherein the processing module further sends a request command to the electronic device through at least one of the plurality of virtual channel when receiving an access request for a File System, and the electronic device implements an operation corresponding to accessed files according to the request command, and replies with an operating result corresponding to the request command.

5. The external device as claimed in claim 4, wherein the request command further comprises path information of a document file of the File System of the electronic device.

6. The external device as claimed in claim 2, wherein the processing module further sends a request command corresponding to a General Purpose I/O pin of the electronic device, and the electronic device further obtains a voltage level of the General Purpose I/O pin according to the request command, and replies by sending the voltage level, grouped according to data, to the processing module.

7. The external device as claimed in claim 1, wherein the internal RANI and the external RANI are the same RANI.

8. An electronic device, adapted to couple to an external device, comprising:
a storage module, configured to store a download agent protocol, a communication interface protocol, and startup firmware for implementing a startup program of the external device; and
a processing module, configured to create a communication channel with the external device according to a communication command of the startup program of the external device and the communication interface protocol, transmit a download agent application to the external device through the communication channel according to a download command and the download agent protocol, and transmit the startup firmware to the external device by the download agent application for implementing the startup

9. The electronic device as claimed in claim 8, wherein the electronic device further creates a plurality of virtual channels coupled with the external device by a middleware.

10. The electronic device as claimed in claim 9, wherein the processing module further implements an operation corresponding to accessed files according to a request command when receiving the request command from the external device, and replies with an operating result to the external device, wherein the request command corresponds to an access request of a File System of the external device.

11. The electronic device as claimed in claim 10, wherein the request command further comprises path information of a document file of the File System of the electronic device.

12. The electronic device as claimed in claim 9, wherein the processing module further receives a request command corresponding to a General Purpose I/O pin of the electronic device from the external device, and the electronic device further obtains a voltage level of the General Purpose I/O pin according to the request command, and replies by sending the voltage level, grouped according to data, to the external device.

13. A method for starting an external device, wherein the external device has an internal RAM and an external RAM, and the external device connects with an electronic device through a communication interface, the method comprising:
receiving a boot command;
creating a communication channel with the electronic device according to the boot command and a communication interface protocol;
downloading a download agent application from the electronic device to the internal RAM through the communication channel according to a download agent protocol;
downloading startup firmware for a startup program from the electronic device to the external RAM by the download agent application; and
implementing the startup program according to the startup firmware.

14. The method as claimed in claim 13, further comprising:
triggering the boot command of the external device when the electronic device detects that the external device connects to the electronic device; and
not triggering the boot command of the external device when the external device does not connect to the electronic device.

15. The method as claimed in claim 14, wherein the electronic device chooses the startup firmware after triggering the boot command.

16. The method as claimed in claim 13, further comprising:
triggering the boot command of the external device manually.

17. A method for data processing, adapted between an electronic device and an external device, wherein the electronic device connects with the external device through a communication interface, the method comprising:
creating a plurality of virtual channels between the electronic device and the external device by a middleware;
sending a request command to the electronic device through the plurality of virtual channels from the external device to the electronic device, wherein the request command corresponds to an access request of a File System;
implementing an operation corresponding to accessed files according to the request command by the electronic device; and
responding by sending an operating result corresponding to the operation corresponding to the accessed files to the external device by the electronic device.

18. The method as claimed in claim 17, wherein the request command further comprises path information of a document file of the File System of the electronic device.

19. The method as claimed in claim 17, wherein the external device further sends a request command corresponding to a General Purpose I/O pin of the electronic device, and the electronic device further obtains a voltage level of the General Purpose I/O pin according to the request command, and replies by sending the voltage level, grouped according to data, to the external device.

20. The method as claimed in claim 17, wherein the communication interface is a Universal Serial Bus interface.
